(19) United States
(12) Patent Application Publication
(10) Pub. No.: US 2018/0176147 A1
(43) Pub. Date: Jun. 21, 2018

(54) SYSTEM AND METHOD TO REDUCE UNCERTAINTY IN GRANT SCHEDULING

(71) Applicant: CABLE TELEVISION LABORATORIES, INC., Louisville, CO (US)

(72) Inventor: JENNIFER ANDREOLI-FANG, Boulder, CO (US)

(21) Appl. No.: 15/845,798

(22) Filed: Dec. 18, 2017

Related U.S. Application Data
(60) Provisional application No. 62/435,407, filed on Dec. 16, 2016.
(60) Provisional application No. 62/435,415, filed on Dec. 16, 2016.

(51) Int. Cl. H04L 12/915; H04W 72/14

(52) U.S. Cl. CPC H04L 47/785; H04W 72/14

(57) ABSTRACT

A system and method reducing grant uncertainty is described. The present system and method is implemented in a two network system having a front haul network, such as an LTE network, and a backhaul network, such as a DOCSIS network. In practice, the present system determines when requests for network resources are not complete satisfied and auto generates a new grant or modifies an existing grant to accommodate the portion of the previous request that was not satisfied. Embodiments are shown and described where implementation occurs in the front haul system and in the backhaul system.

### RELATED APPLICATIONS

This application claims priority to U.S. Provisional Application Ser. No. 62/435,407 (hereinafter “'407 provisional”), filed 16 Dec. 2016, and U.S. Provisional Application Ser. No. 62/435,415 (hereinafter “'415 provisional”), filed 16 Dec. 2016, both of which are incorporated in their entirety herein by reference.

### TECHNICAL FIELD

This disclosure relates in general to the field of communications and, more particularly, techniques for integration of wireless access and wireline networks.

### BACKGROUND

Today's communication systems may include separate wireless and wireline portions, each of which may be owned and controlled by different operators. Some network operators, for example Multiple System Operators (“MSOs”), use wireline networks, such as Data Over Cable Service Interface Specification (“DOCSIS”) networks, for backhauling traffic such as Internet traffic, mobile traffic, etc. These network operators have limited to no visibility into portions of the backhauled traffic destined for a second network, such as backhauled mobile traffic. Typically, each network type, for example DOCSIS and LTE, utilize separate traffic scheduling algorithms, QoS, segmentation protocols, etc. As a result, currently when these types of networks are combined, the resulting architecture may be inefficient and may result in undesirable latency increases.

### SUMMARY OF THE INVENTION

A method for reducing uncertainty in grant scheduling in a system configure from front haul network and a backhaul network is disclosed. The present system and method first determines difference between the amount of resources requested from a front haul network to transmit data held in the memory of a UE and that granted in response to that request. Next, the system and method determined if the data received contains any segmented packets such that a first portion of the segmented pack is received by the system and a second portion of the segmented packet remains at the transmitting device. The system and method then stores the first portion of the segmented packet in memory and generate a grant associated with the second portion of the segmented packet. Upon receipt of the second portion of the segmented packet, the system and method combines the first portion with the second portion to form a complete packet. The complete packet is then transmitted through the backhaul network to its destination.

### BRIEF DESCRIPTION OF THE INVENTION

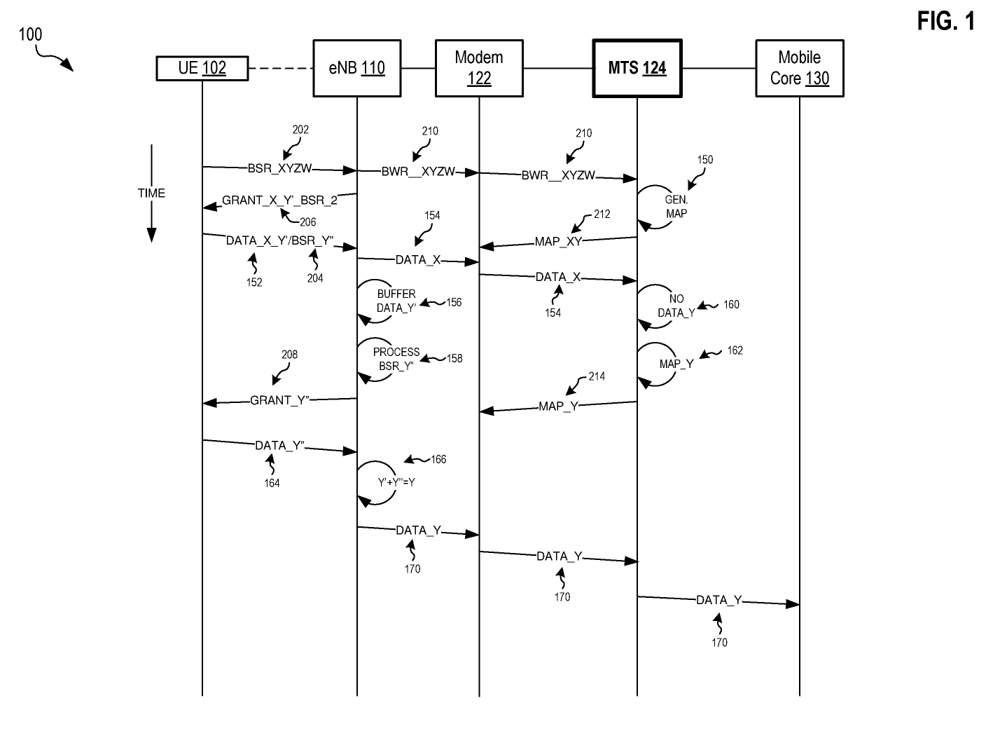

FIG. 1 shows one exemplary simplified block diagram and timing diagram for a Small Cell-BackHaul (SC-BH) communication system with control placed in the Modem Termination System, in an embodiment.

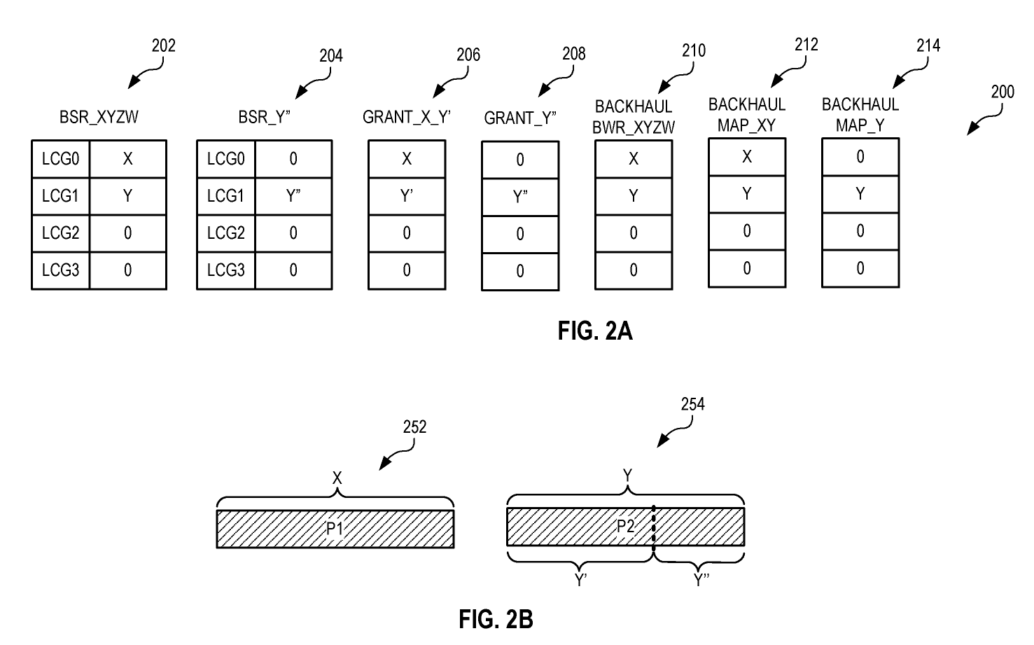

FIG. 2A shows the multiple Buffer Status Reports (BSRs), Mini-slot Allocation Packets (MAPs), Grants, and a Bandwidth Report (BWR) as utilized in FIG. 1, in an embodiment.

FIG. 2B shows data packets P1 having X bytes of data and P2 having Y bytes of data for LCG0 and LCG1 respectively, with P2 segmented in to a first segments of Y′ bytes of data and a second segment of Y″ bytes of data, in an embodiment.

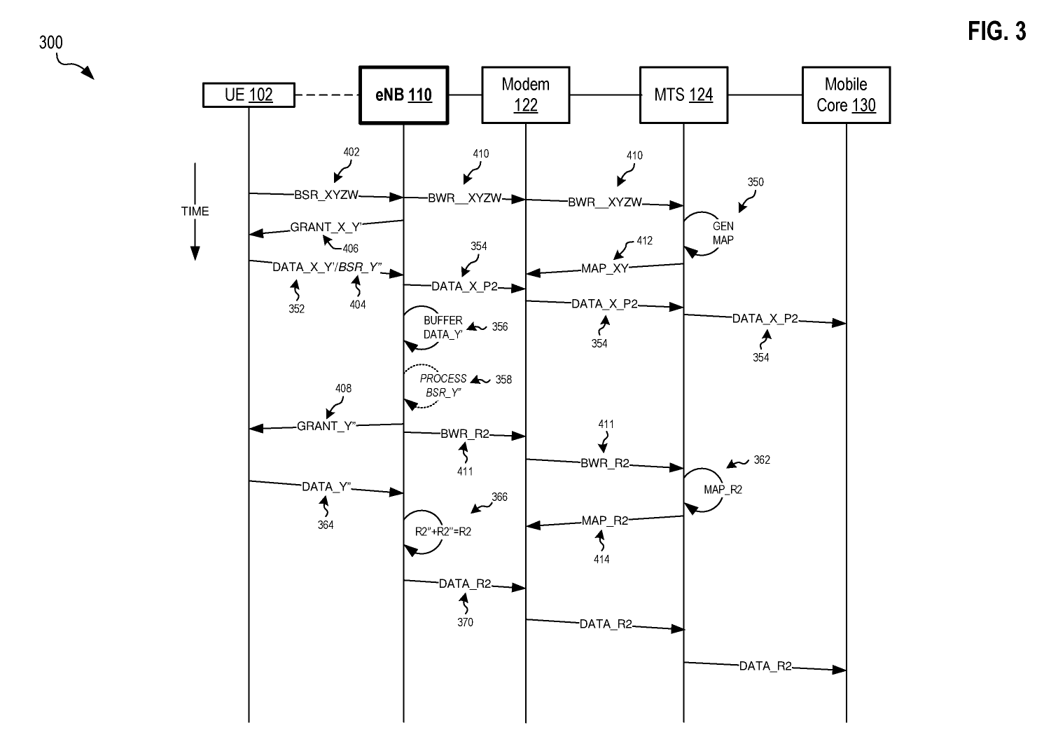

FIG. 3 shows one exemplary simplified block diagram and timing diagram for a Small Cell-BackHaul (SC-BH) communication system with control placed in the eNodeB, in an embodiment.

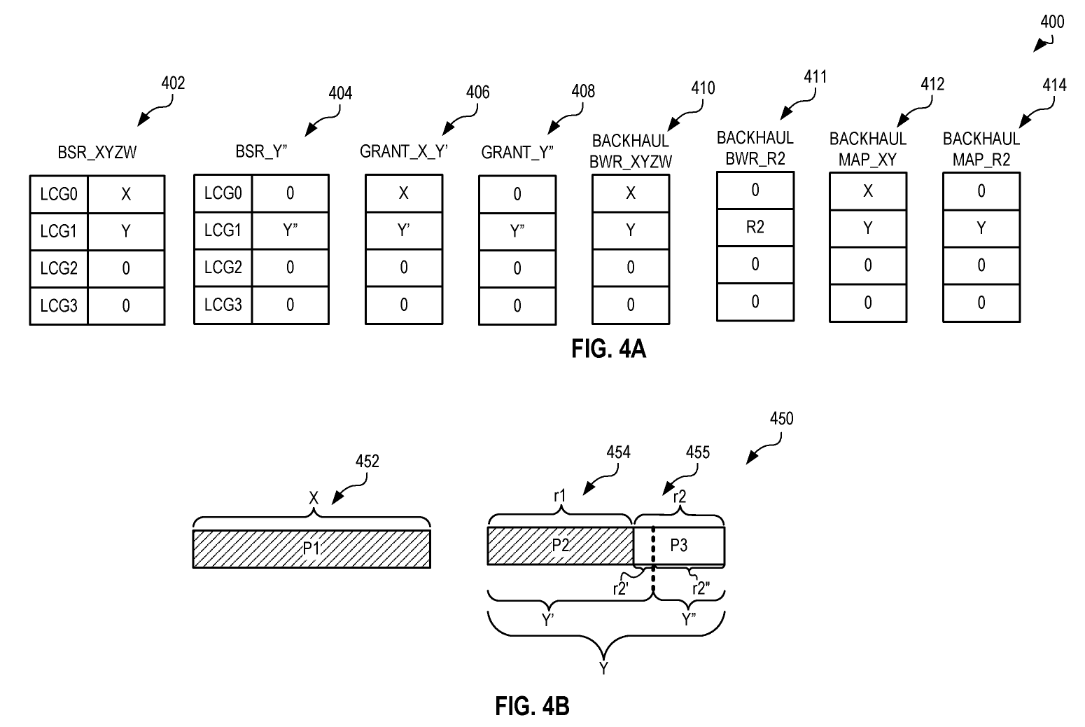

FIG. 4A shows the multiple Buffer Status Reports (BSRs), Mini-slot Allocation Packets (MAPs), Grants, and Bandwidth Reports (BWRs) as utilized in FIG. 3, in an embodiment.

FIG. 4B shows data packets P1 having X bytes of data, P2 having Y bytes of data, and P3 having bytes of data for LCG0 and LCG1 respectively, with P1 segmented in to a first segments of Y′ bytes of data and a second segment of Y″ bytes of data, in an embodiment.

### DETAILED DESCRIPTION OF THE FIGURES

The present system and method solves some of the latency issues that arise from backhauling a second networks data of a first network. One non-limiting example of such a coordinated, dual-network system is one in which the second network is an LTE network and the first network (the backhaul network) is a DOCSIS implemented network. It will be understood that the first and second networks may be any two networks as longs as they utilize different protocols. Furthermore, it will be understood that either network may be wired or wireless, and that a third, forth, etc. network may be added to the present systems and methods without departing from the scope herein. On example of such a multi-network system is one that includes an LTE signal that transmits to a mobile core via a MoCA network and a DOCSIS network. Other possible embodiments would be apparent to the skilled artisan after reading the present disclosure.

FIG. 1 shows one exemplary simplified block and timing diagram for a Small Cell-BackHaul (SC-BH) communication system 100 with control placed in a Modem Termination System (MTS) 124, in an embodiment. FIG. 1 is best read in combination with FIGS. 2A and 2B. FIG. 2A shows the various Buffer Status Reports (BSRs), Mini-slot Allocation Packets (MAPs), Grants, and a Bandwidth Report (BWR) as utilized in the embodiment of FIG. 1. FIG. 2B shows data packets P1 for LCG0 having X bytes of data and P2 for LCG1 having Y bytes of data, with P2 segmented into a first segments of Y′ bytes of data and a second segment of Y″ bytes of data.

System 100 includes a user equipment (UE) 102, an eNodeB (eNB) 110, a modem 122, the MTS 124, and a mobile core 130. The front haul system includes UE 102, eNB 110, and mobile core 130. The backhaul system includes modem 124 and MTS 124. UE 102 is represented in wireless communication with eNB 110, which communicates with and through modem 122, MTS 124, and mobile core 130 via wired communication. Generally, eNB 110 and the modem 122 are connected via a Gigabit Ethernet connection and the propagation time of the message is negligible. In other embodiments, the eNB and the modem are co-located, configured in the same box, or even on the same circuit board. The wireless and wired communication represented in system 100 may just as easily be all wired, all wireless, or any mixture of the two. Furthermore, wireless communications may be any known or future wireless communication type, examples of which include but are not limited to radio frequency (RF) such as LTE, Wi-Fi, Bluetooth, 3G, 4G, 5G, satellite, etc., or optical such as coded visible or non-visible light, laser, etc., or even quantum, or any other non-wired mechanism without limitation. Still further, wired communications may be any known or future wired communication type, examples of which include but are not limited to DOCSIS, Multimedia over Coax Alliance (MoCA), DSL, any passive optical network, or any other wired mechanism without limitation.

System 100 is shown in a streamlined representation to facilitate understanding and simplify explanation, although it will be understood that additional UEs 102, eNBs 110, modems 122, MTSs 124, and mobile cores 130 may be incorporated without departing from the scope herein. In additional or in an alternative, all or portions of the components shown in FIG. 1 may be virtualized. For example, the upper layers of the MTS 124 may be split from the PHY and/or MAC layers (not shown) to create a virtualized MTS (vMTS). In addition, the eNB 110 may be split into a remote small cell, which may be in direct communication with the modem 122, and a centralized small cell, which is virtualized within the mobile core 130.

A BSR_XYZW 202 is shown in the present system and methods as an LTE embodiment. BSR_XYZW 202 is represented with X bytes of data in LCG0, and Y bytes of data in LCG1, where X and Y do not include additional information regarding the data stored in UE 202's buffer for each of the logical channel groups. For example, X and Y do not describe the number of packets in a logical channel group. To simplify explanation LCG2 and LCG3 are represented in BSR_XYZW with zero bytes of data. BSR_Y″ 204 is shown with Y″ bytes of data in LCG1.

Grant_X_Y′ 206 is an LTE grant provided by eNB 110 to UE 102 in response to the receipt of BSR_XYZW 202, discuss further below. Grant 206 optionally includes a grant for a second buffer status report, BSR_2. Grant_Y″ is an LTE grant provided by eNB 110 to UE 102. Grant_Y″ may be generated in response to receipt of optional BSR_Y″ 204 or may be automatically generated at eNB 110 after the generation of grant_X_Y′ 206, which does not satisfy BSR 202, discuss further below.

A backhaul Bandwidth Report_XYZW 210 is shown having a request for backhaul resources to accommodate X+Y bytes of data.

A backhaul MAP_XY 212 is an upstream bandwidth allocation on the backhaul system generated at MTS 124 for modem 122 to accommodate X+Y bytes of data from UE 102 to mobile core 130 via the backhaul system.

A backhaul MAP_Y 214 is an upstream bandwidth allocation on the backhaul system generated at MTS 124 for modem 122 to accommodate Y bytes of data from UE 102 to mobile core 130 via the backhaul system.

FIG. 2B shows a data packet P1 252 having X bytes of LCG0 data and a data packet P2 254 having Y bytes of LCG1 data. P2 254 is symbolically shown segmented into two portions, portion Y′ and Y″.

In the embodiment of system 100, UE 102 has data for transmission to mobile core 130. To initiate this process, UE 102 sends a buffer status report (BSR), shown as a BSR_XYZW 202, to eNB 110. X, Y, Z, W in BSR_XYZW 202 represents an amount of data stored measured in bytes that are stored in UE 102's buffer of each of the logical channel groups LCG0, LCG1, LCG2, LCG3, respectively.

In the fronthaul system, after eNB 110 receives the BSR_XYZW 202 it generates an LTE UL grant, grant_X_Y′ 206, and eNB 110's MAC layer generates a BandWidth Report (BWR) message, BWR_XYZW 210. The BWR message indicates the amount of bandwidth requested to accommodate BSR 202 and the grant time provided in the grant, grant 206. The BWR 210 message is forwarded to the modem 122. In the present example, eNB 110 does not have enough resources to completely satisfy BSR 202 such that in grant_X_Y′ 206, there are only enough resources scheduled to accommodate a portion of LCG1 data, namely Y′ bytes of data as detailed in FIGS. 2A and 2B.

BWR 210 is then forwarded to the MTS 124, which triggers MTS 124 to generate 150 a MAP_XY 212, which is an upstream bandwidth allocation on the backhaul system for modem 122 to accommodate data from UE 102 and eNB 110.

While the backhaul system is transmitting and processing BWR 210 and generating MAP 212, UE 102 of the fronthaul system receives grant 206, which accommodates X bytes of date for LCG0 and Y′ bytes of data for LCG1, where Y′ is less than the Y bytes of data that are in UE 102's buffer for LCG1. UE 102 then transmits all of the data in LCG0, X bytes of data, and only a portion of the data in LCG1, Y′ bytes of data as data_X_Y′ 152. UE 102 also may optionally transmit a BSR Y″ 204 to request bandwidth for the transmission of the remaining data left in the buffer for LCG1, a segment of packet P2 consisting of Y″ bytes of data.

eNB 110 receives data_X_Y′ 152 and prepares data_X 154 for transmission to modem 122. Prior to the receipt of data_X 154 at modem 122 MAP_XY 212 arrives at modem 122 which prepares modem 122 to transmits data 154 when it arrives. Because a partial segment cannot be sent from eNB 110 to mobile core 130, only the LCG0 data, consisting of X bytes, can be sent from eNB 110 to modem 122, while the partial segment of LCG1 data consisting of Y′ bytes of data, cannot be sent. It will be understood that MAP 212 allocates more bandwidth than is required for the transmission of the LCG0 data, namely by the bandwidth to accommodate Y bytes of LCG1 data. In a prior art system eNB 110 would throw the partial LCG1 data away and UE 102 would have to submit a new BSR requesting resources to transmit the entirety of LCG1 data again, that is, all Y bytes. In the present system and method, the Y′ bytes of data are stored 156 at eNB 110. In an alternative embodiment the Y′ bytes of data may be stored at modem 122 (not shown). Data_X 154 is sent from modem 122 to MTS 124.

In the present embodiment, discussed partially above, UE 102 sends a new BSR_Y″ 204 to request a grant to transmit the remaining LCG1 data. BSR 204 is processed 158 at eNB 110 and grant_Y″ 208 is generated and sent to UE 102.

In an alternative embodiment (not shown) eNB 110 recognizes that BSR 202 requested resources for X+Y bytes of data, but only the bandwidth to accommodate X+Y′ bytes of data were allocated in grant 206. So, eNB 110 automatically generates a new grant 208 for the remaining Y″ bytes of data associated with LCG1, which is sent to UE 102.

MTS 124 process the received data_X 154 and determines 160 that only X-bytes of data are present. Due to this determination MTS 124 generates 162 MAP_Y 214 for the transmission of the LCG1 data consisting of Y bytes of data, which is sent to modem 122.

After UE 102 receives grant_Y″ 208 it sends data_Y″ 164 to eNB 110. eNB 110 then combines 166 data_Y″ with stored data_Y′ to form data_Y 170, which is sent to mobile core 130 via modem 122 and MTS 124.

FIGS. 3, 4A, and 4B are best viewed together.

FIG. 3 shows one exemplary simplified block diagram and timing diagram for a Small Cell-BackHaul (SC-BH) communication system with control placed in the eNodeB, in an embodiment. FIG. 4A shows the multiple Buffer Status Reports (BSRs), Mini-slot Allocation Packets (MAPs), and Bandwidth Reports (BWRs) as utilized in FIG. 3, in an embodiment. FIG. 4B shows data packets P1 having X bytes of data, P2 having Y bytes of data, and P3 having bytes of data for LCG0 and LCG1 respectively, with P1 segmented in to a first segments of Y′ bytes of data and a second segment of Y″ bytes of data, in an embodiment.

System 300 includes user equipment (UE) 102, eNodeB (eNB) 110, modem 122, MTS 124, and mobile core 130 similar to system 100. Also similar to system 100, the front haul system includes UE 102, eNB 110, and mobile core 130 and the backhaul system includes modem 124 and MTS 124.

System 300 is shown in a streamlined representation to facilitate understanding and simplify explanation, although it will be understood that additional UEs 102, eNBs 110, modems 122, MTSs 124, and mobile cores 130 may be incorporated without departing from the scope herein. In additional or in alternative embodiments, all or portions of the components shown in FIG. 3 may be virtualized, similar to system 100.

A BSR_XYZW 402 is shown in the present system and methods as an LTE embodiment. It will be understood that other embodiments will utilize the relevant proprietary system and methods. BSR_XYZW 402 is represented with X bytes of data in LCG0, and Y bytes of data in LCG1, where X and Y does not include additional information regarding the data stored in UE 202's buffer for each of the logical channel groups, such as the number or size of packets associated with each logical channel group, see the discussion for FIG. 4B below. To simplify explanation LCG2 and LCG3 are represented in BSR_XYZW with zero bytes of data such that Z=0 and W=0. BSR_Y″ 404 is shown with Y″ bytes of data in LCG1.

A Grant_X_Y′ 406 is an LTE grant provided by eNB 110 to UE 102 in response to the receipt of BSR_XYZW 402, discuss further below. Grant 406 optionally includes or is sent with a grant for a second buffer status report, similar to system 100 but not shown here. A Grant_Y″ 408 is an LTE grant provided by eNB 110 to UE 102. Grant_Y″408 may be generated in response to receipt of optional BSR_Y″ 404 or may be automatically generated at eNB 110 after the generation of grant_X_Y′ 406. During the process of generating grant_X_Y′ 406 (or after is a separate process) eNB 110 determines that grant_X_Y′ 406 does not satisfy BSR 402. Such a determination may cause eNB o automatically generate grant_Y″ 408. Alternatively, grant_Y″ 408 may be generated by eNB 110 after the transmission of grant_X_Y′ 406 due to eNB 110's a determination by eNB 110 that grant_X_Y′ 406 does not satisfy BSR 402 such that a new grant to accommodate the remaining data is necessary.

A backhaul BWR_XYZW 410 is shown having a request for backhaul resources to accommodate X+Y bytes of data.

A backhaul MAP_XY 412 is an upstream bandwidth allocation on the backhaul system generated at MTS 124 for modem 122 to accommodate X+Y bytes of data from UE 102 to mobile core 130 via the backhaul system.

A backhaul MAP_Y 414 is an upstream bandwidth allocation on the backhaul system generated at MTS 124 for modem 122 to accommodate Y bytes of data from UE 102 to mobile core 130 via the backhaul system.

FIG. 4B shows a data packet P1 452 having X bytes of LCG0 data. FIG. 4B also shows LCG1 data 450 with Y bytes of data split between a data packet P2 454 and a data packet P3 455. P2 454 is shown with r1 bytes of data and P3 455 is shown with r2 bytes of data such that r1+r2=Y bytes of data. LCG1 data 450 is symbolically shown segmented into two portions. The first segment or portion is shown with Y′ bytes of data and the second segment or portion is shown with Y″ bytes of data such that Y′+Y″=Y bytes of data. In addition, P3 455 can be viewed as segmented into two portions having r2′ bytes of data and r2″ having bytes of data. More will be discussed regarding this below in association with the combined descriptions of FIGS. 3, 4A and 4B.

In the embodiment of system 300, UE 102 has data for transmission to mobile core 130. To initiate this process, UE 102 sends a buffer status report (BSR), shown as a BSR_XYZW 402, to eNB 110. X, Y, Z, W in BSR_XYZW 402 represents an amount of data stored measured in bytes that are stored in UE 102's buffer of each of the logical channel groups LCG0, LCG1, LCG2, LCG3, respectively.

In the fronthaul system, after eNB 110 receives BSR_XYZW 402 it generates an LTE UL grant, grant_X_Y′ 406, and eNB 110's MAC layer generates a BandWidth Report (BWR) message, BWR_XYZW 410. The BWR message indicates the amount of bandwidth requested to accommodate BSR 202 and the grant time provided in the grant, grant 406. BWR 410 message is forwarded to the modem 122. In the present example, eNB 110 does not have enough resources to completely satisfy BSR 402 such that in grant_X_Y′ 406, there are only enough resources scheduled to accommodate a portion of LCG1 data, namely Y′ bytes of data as detailed in FIGS. 4A and 4B.

BWR 410 is then forwarded to the MTS 124, which triggers MTS 124 to generate 350 a MAP_XY 412, which is an upstream bandwidth allocation on the backhaul system for modem 122 to accommodate data from UE 102 and eNB 110.

While the backhaul system is transmitting and processing BWR 410 and generating MAP 412, UE 102 of the fronthaul system receives grant 406, which accommodates X bytes of date for LCG0 and Y′ bytes of data for LCG1, where Y′ is less than the Y bytes of data that are in UE 102's buffer for LCG1. UE 102 then transmits all of the data in LCG0, X bytes of data, and only a portion of the data in LCG1, Y′ bytes of data as data_X_Y′ 352. UE 102 also may optionally transmit a BSR Y″ 404 to request bandwidth for the transmission of the remaining data left in the buffer for LCG1, a segment of packet P3 consisting of Y″ bytes of data.

eNB 110 receives data_X_Y′ 352 and prepares data_X_P2 354 for transmission to modem 122. Prior to the receipt of data_X 354_P2 at modem 122 MAP_XY 412 arrives at modem 122 which prepares modem 122 to transmits data 354 when it arrives. Because a partial segment cannot be sent from eNB 110 to mobile core 130, only the LCG0 data consisting of X bytes, and P1 454 of LCG1 consisting of r1 bytes of data, can be sent from eNB 110 to modem 122, while the partial segment of LCG1 data consisting of r2′ bytes of data, cannot be sent. It will be understood that MAP 412 allocates more bandwidth than is required for the transmission of the LCG0 data and P2 of LCG1. In a prior art system eNB 110 would throw the partial LCG1 data away and UE 102 would have to submit a new BSR requesting resources to transmit the entirety of P2 data in LCG1. In the present system and method, the r2′ bytes of data are stored 356 at eNB 110. In an alternative embodiment the r2′ bytes of data may be stored at modem 122 (not shown). Data_X_P2 354 is then sent from modem 122 to MTS 124.

In an embodiment discussed partially above, UE 102 optionally sends a new BSR_Y″ 404 to request a grant to transmit the remaining LCG1 data. BSR_Y″ 404 is processed 358 at eNB 110 and grant_Y″ 408 is generated and sent to UE 102.

In an alternative embodiment (not shown) eNB 110 determines that BSR 402 requested resources for X+Y bytes of data, but only the bandwidth to accommodate X+Y′ bytes of data were allocated in grant 406. Due to this determination eNB 110 automatically generates a new grant 408 to accommodate the remaining Y″ bytes of data associated with LCG1, which is sent to UE 102.

When eNB 100 process generates grant_Y″ 408 it may also generate a BWR_R2 411 such that eNB 110 may forward all of the packet P3 455 data to the mobile core 130 after data y″ 364 arrives are eNB 110. Upon receipt of BWR_R2 411 at MTS 124 generates 362 MAP_R2 414 for the transmission of the P3 data 455 data consisting of r2 bytes of data, which is sent to modem 122. It will be understood that system 100 and system 300 may handle segmentation in the same or a similar manner when it occurs within a single packet (see P2 in FIG. 2B) as described in systems 100, 200, 252, and 254 or when a plurality of packets is involved (see P2 and P3 in FIG. 4B), such as is the case with system 300, 400, 452, and 450.

After UE 102 receives grant_Y″ 408 it sends data_Y″ 364 to eNB 110. eNB 110 then combines 366 data_r2″ with stored data_r2′ to form data_r2 370, which is sent to mobile core 130 via modem 122 and MTS 124.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for reducing uncertainty in grant scheduling in a system configure from front haul network and a backhaul network, comprising:
determining an amount of data difference between a request for front haul network resources from a transmitting device and a grant generated at the receiving device in response to that request;
determining if a received data contains a segmented packet wherein a first portion of the segmented pack is received at the system and a second portion of the segmented packet is at the transmitting device;
storing the first portion of the segmented packet in memory;
generating a grant associated with the second portion of the segmented packet;
upon receipt of the second portion of the segmented packet, combining the first portion with the second portion to form a complete packet; and
transmitting the complete packet through the backhaul network to its destination.

2. The method of claim 1, wherein the request for front haul network resources is a buffer status report (BSR).

3. The method of claim 1, wherein the front haul system is a Long Term Evolution (LTE) system.

4. The method of claim 1, wherein the backhaul system is a Data Over Cable Service Interface Specification (DOCSIS) system.

5. The method of claim 1, wherein the transmitting device is an LTE User Equipment (UE).

6. The method of claim 1, wherein the receiving device is an LTE eNodeB.

7. The method of claim 1, wherein generating the grant associated with the second portion of the segmented packet is automatically generated at the receiving device.

8. The method of claim 1, wherein generating the grant associated with the second portion of the segmented packet is generated in response to a second request for front haul network resources from the transmitting device to send only the un-transmitted portion.

9. The method of claim 1, further comprising generating a second backhaul grant in response to determining a difference between the first backhaul grant and the received data associated with that grant.

10. The method of claim 9, wherein the first and second backhaul grants are a first and second Mini-slot Allocation Packet (MAP).
